(19) United States
(12) Patent Application Publication
(10) Pub. No.: US 2003/0031457 A1
(43) Pub. Date: Feb. 13, 2003

(54) Electronic album device and file copying method for use in the device

(75) Inventors: Takahiro Miomo, Osaka (JP); Taiichiro Sugi, Osaka (JP); Kazuaki Hata, Osaka (JP); Atsushi Yamada, Osaka (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 10/207,084

(22) Filed: Jul. 30, 2002

(30) Foreign Application Priority Data
Jul. 31, 2001 (JP) 2001-231377
Mar. 29, 2002 (JP) 2002-097850

(51) Int. Cl. H04N 5/76; H04N 5/781

(52) U.S. Cl. 386/46; 386/125

(57) ABSTRACT

An electronic album device of the invention recognizes the respective folder structures of a card and a disk, and copies files from the card to the disk by changing the folder number of each folder on the card to a number M″ which is different from any of folder numbers on the disk while maintaining the same folder structure prepared on the card. Even in the case where the files are copied from the card to the disk and then written back to the card again, the file on the card can be reproduced with the digital camera originally used.

### FILED OF THE INVENTION

The present invention relates to an electronic album device for saving and accumulating a plurality of files obtained by photographing images with a digital camera, and to a file copying method for use in the device.

### BACKGROUND OF THE INVENTION

Small-sized memory cards having a capacity of tens of megabytes have heretofore been used for digital cameras for recording image data obtained by photographing. Such cards include Compact Flash (registered trademark, hereinafter referred to as “CF cards” and Smart Media (registered trademark, hereinafter referred to as “SM cards”). With the memory card inserted in a memory card connector provided on the camera body, image data as to a plurality of freeze-frame pictures or moving pictures can be recorded on the memory card.

However, the number of images to be recorded on one memory card is limited; many memory cards are necessary for saving a large number of images, so that a cumbersome managing procedure is not only required for memory cards but memory cards need to be handled frequently when a desired image is to be retrieved from among a large number of images, hence the problem of troublesome procedures.

Accordingly, the present applicant has developed an electronic album device which is loadable with a memory card and adapted to read all image data recorded on the memory card in response to the depression of a save button by the user and record the read data on a CD-R (Compact Disc-recordable) incorporated in the album device (see JP-A No. 2000-311106).

The album device is loadable with two kinds of cards, i.e. CF card and SM card, since these two kinds of cards are available as recording media for digital cameras. Data can be copied between the desired one of the two kinds of memory cards and the CD-R.

The electronic album device is adapted to write freeze-frame pictures as recorded on about ten memory cards, to a CD-R having a capacity, for example, of 640 MB. Thus, a large quantity of freeze-frame pictures can be collectively managed by the album device.

It is likely that the album device will be loaded with a memory card having written thereto image files by digital cameras of different manufacturers to copy the image files from the memory card to a CD-R or like disk medium for storing. Different manufacturers prepare folders of different structures on memory cards, so that if the folder structure is altered as desired for copying and the image data is written back to the memory card, it is no longer possible to reproduce the image data on the original camera.

### SUMMARY OF THE INVENTION

Accordingly, an object of the present invention is to provide an electronic album device which is useful even in the case where files obtained by photographing images with a digital camera are copied from a data recording medium to a data saving medium and then written back to the data recording medium again, enabling the original digital camera to reproduce the files on the data recording medium.

The present invention provides an electronic album device which comprises:

first recognizer for recognizing a folder structure prepared on a data recording medium,

second recognizer for recognizing a folder structure prepared on a data saving medium,

folder name preparator for preparing a new folder name A″ by changing a folder number M constituting the folder name A of each folder in the folder structure on the data recording medium to a number M″ different from any of folder numbers M′ on the data saving medium,

folder structure preparator for preparing on the data saving medium a new folder structure having the same folder construction as the data recording medium with use of the new folder name A″, and

copying processor for copying the file from the data recording medium to the data saving medium with the new folder structure prepared on the data saving medium.

In copying files from the data recording medium to the data saving medium by the album device of the invention, the folder number M of each folder on the data recording medium is changed to a number M″ which is different from any of folder numbers M′ on the data saving medium, so that the desired file provided under the desired one of the folders can be read using the new folder structure.

Further when the file is copied from the data recording medium to the data saving medium, the same folder structure is maintained, so that when the file is thereafter written back from the data saving medium to the data recording medium with the same folder structure maintained, the file can be reproduced using the original digital camera.

Stated more specifically, the folder name A of each folder comprises the folder number M and a folder identification name N, and the folder name preparator prepares the new folder name A″ while maintaining the same folder identification name N.

As described above, the folder structure prepared on the data recording medium differs from manufacturer to manufacturer. Accordingly, even if the file is written back from the data saving medium to the data recording medium, the file can not be reproduced using a digital camera which is different from the one originally used.

With digital cameras, a name peculiar to the manufacturer is used as the folder identification name N of the folder name on the data recording medium. Accordingly, in copying the file from the data recording medium to the data saving medium using the specific construction described, the same folder identification name N of the folder name is maintained. When the file is to be written back from the data saving medium to the data recording medium by the user, the folder identification name N of the folder name readily indicates the digital camera of particular manufacturer by which the file can be reproduced.

Stated more specifically, the folder structure preparator prepares the new folder structure by maintaining the same file name B defined under each folder.

Since the same file name B defined under each folder is maintained, the original file name, if memorized, makes it possible to readily retrieve the desired file from among a plurality of files provided on the data saving medium, hence facilitated file management.

Further stated more specifically, for a plurality of moving picture files defined under a moving picture folder, a moving picture folder is prepared on the data saving medium, and the album device comprises moving picture file definer for defining all the moving picture files under the moving picture folder prepared while maintaining the same file name for each of the moving picture files.

For use with a digital camera for preparing a moving picture folder “VCLIP” on the data recording medium by photographing moving images, this specific construction becomes useful for the reproduction of the file when the moving picture file written to the data recording medium is copied to the data saving medium and then written back to the data recording medium.

Further stated more specifically, in the case where the folder structure on the data recording medium is in conformity with a predetermined format, the folder name preparator performs the folder name preparing operation, and the folder structure preparator performs the folder structure preparing operation while maintaining the predetermined format.

The “DCF standard” is provided for digital cameras so as to use a common folder structure for data recording media of different manufacturers. In the case where the folder structure prepared on the data recording medium is in conformity with the predetermined format as described above, the folder structure preparing operation is performed on the data saving medium with the predetermined format maintained.

For use with digital cameras for preparing a folder structure of predetermined format on the data recording medium, this assures reliable reproduction of files in the case where the files are copied from the data recording medium to the data saving medium and then written back to the data recording medium.

Further stated more specifically, the album device comprises:

nonconforming folder name preparator for preparing a new folder name A₀ having a folder number M₀ different from any folder number constituting the folder name in the uppermost stratum on the data saving medium, and

nonconforming folder structure preparator for preparing on the data saving medium a new folder structure having under the new folder name A₀ the same folder name and the same file name as each folder name A prepared on the data recording medium and as the file name a defined under the folder name A, when the folder structure on the data recording medium includes a portion in conformity with the predetermined format and a portion not in conformity with the format.

In the case of two files which are prepared by some kind of digital cameras and which are related with each other, it is likely that one of the files will be defined under a folder provided in a portion in conformity with the DCF standard, with the other file defined under a folder provided in a portion not in conformity with the DCF standard. These two files may be related with each other by the folder number and file name of the folder.

Suppose in copying files from the data recording medium to the data saving medium, the folder number or file names of the folder defining two files which are related with each other are changed. The relationship between the two files by the folder number and file names will then be broken. Accordingly, even if the files are written back from the data saving medium to the data recording medium of the original camera, it is no longer possible to reproduce the two related files.

Accordingly, in the case where the folder structure of the data recording medium includes a portion in conformity with the DCF standard and a portion not in conformity with this standard as described above, the same folder name A and the same file name a defined under the folder name A are maintained in preparing a new folder structure on the data saving medium. When a plurality of files on the data recording medium are related with each other by the folder number and file names, this relation will not be broken by virtue of the above feature. When the files are thereafter written back from the data saving medium to the data recording medium, with the same folder name A and the same file name a maintained, the files related with each other can be reproduced by the original digital camera. The other files can also be reproduced similarly.

Further in copying files from the data recording medium to the data saving medium, a new folder name A₀ having a folder number M₀ different from any folder number constituting the folder name in the uppermost stratum on the data saving medium is prepared, and each folder on the data recording medium is defined under the folder name A₀, so that the desired file provided under the desired folder can be read from the new folder structure.

Further stated more specifically, the album device comprises judge for judging whether each of the folders defined on the data recording medium is related with any other folder, and the folder name preparator performs the folder name preparing operation for the folder which is not related with any other folder and which is the folder defined in the portion conforming to the predetermined format or is included among folders defined in the conforming portion, and the folder structure preparator defines the new folder name prepared for the nonrelated folder on the data saving medium while maintaining the predetermined format.

According to this feature, the above-mentioned nonrelated folder has its folder number M changed to a number M″ which is different from any of the folder numbers M′ on the data saving medium and is defined on the data saving medium according to the format conforming to the DCF standard. When the files defined under such a folder are written back from the data saving medium to the data recording medium with the same folder structure maintained, the files can be reproduced by the digital camera for preparing the folder structure conforming to the DCF standard.

Even when the files obtained by photographing images with a digital camera are copied from a data recording medium to a data saving medium and then written back to the data recording medium again with use of the electronic album device of the invention, the files on the recording medium can be reproduced by the original camera.

When the album device is used which is adapted to prepare a new folder name at the uppermost position on the data saving medium, and in the case where the files on the data recording medium are written back thereto again via the data saving medium, the files can be reproduced by the original digital camera even if the folder structure on the recording medium includes a portion not in conformity with the predetermined format.

### BRIEF DESCRIPTION OF THE DRAWINGS

FIG. 1 is a perspective view showing the appearance of an electronic album device embodying the invention;

FIG. 2 is a perspective view showing the appearances of a memory stick and a memory stick adaptor;

FIG. 3 is a block diagram showing the construction of the album device;

FIG. 4 is a flow chart showing a procedure for saving a file from a card or memory stick to a disk;

FIG. 5 is a flow chart showing the saving procedure in detail;

FIG. 6 is a first fragmentary view of FIG. 5;

FIG. 7 is a second fragmentary view of FIG. 5;

FIG. 8 is a third fragmentary view of FIG. 5;

FIG. 9 is a fourth fragmentary view of FIG. 5;

FIG. 10 is a fifth fragmentary view of FIG. 5;

FIG. 11 is a diagram showing the folder structure of the card;

FIG. 12 is a diagram showing the folder structure of the disk before saving;

FIG. 13 is a diagram showing the folder structure of the disk after saving from the card;

FIG. 14 is a diagram showing the folder structure of the memory stick; and

FIG. 15 is a diagram showing the folder structure of the disk after saving from the memory stick.

### DETAILED DESCRIPTION OF EMBODIMENT

An embodiment of the invention will be described below in detail with reference to the drawings.

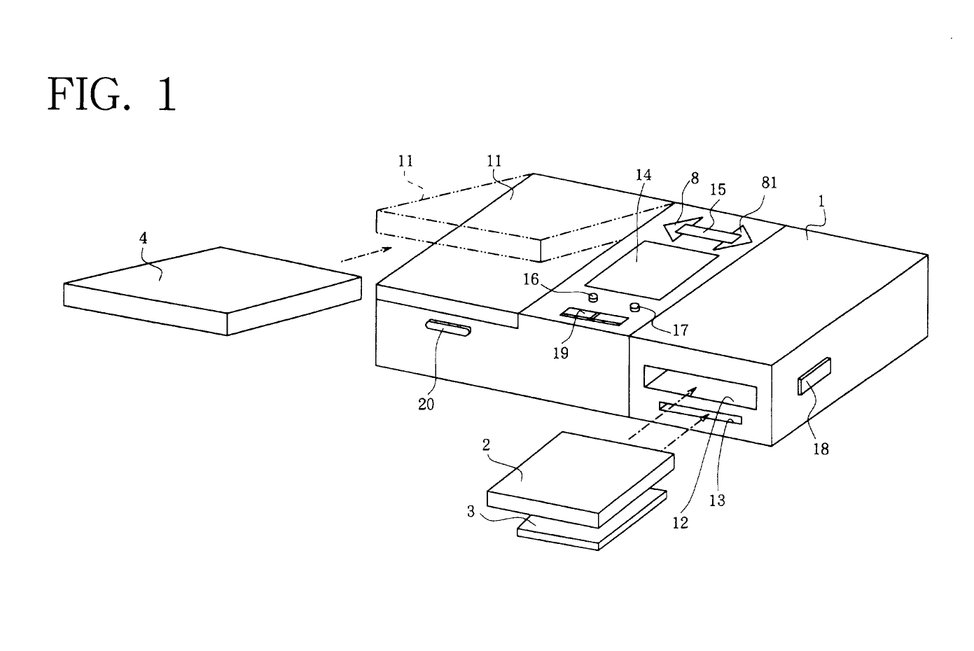

The present invention provides an electronic album device which comprises, as shown in FIG. 1, a portable small case 1 having a CF card inlet 12 and an SM card inlet 13 which are formed in its front wall. A CF card 2 and an SM card 3 can be inserted through the inlets 12, 13, respectively. When inserted through the CF card inlet 12, the CF card 2 is accommodated in its entirety in the case 1 and set in a predetermined data write/read position (not shown). When inserted through the SM card inlet 13, the SM card 3 is set in a predetermined data write/read position (not shown), with part of card projecting outward from the case 1.

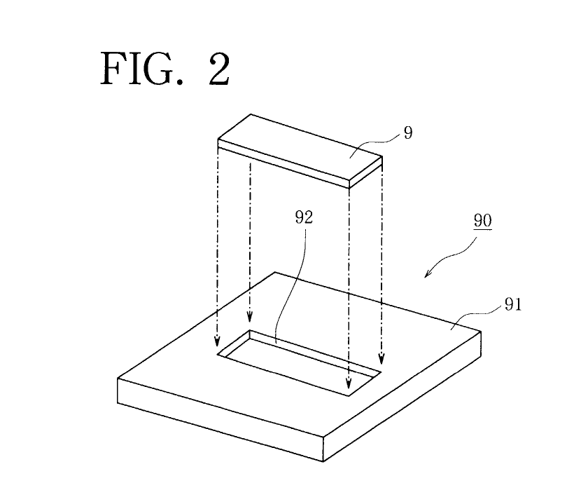

The album device is adapted to write data also to a memory stick 9 and to read data therefrom. FIG. 2 shows a memory stick adaptor 90, which can also be inserted through the CF card inlet 12. The adaptor 90 has a casing 91 having the same external dimensions as the CF card 2, and an upper wall which is provided with a portion 92 for accommodating the memory stick 9.

As shown in FIG. 1, the case 1 is provided with a lid 11 of the kangaroo pocket type which is opened by manipulating a disk delivery lever 20 as indicated in chain lines. With the lid 11 opened, an optomagnetic disk 4 is loaded onto a holder (not shown) provided on the rear side of the lid 11, and the lid 11 is thereafter closed, whereby the disk 4 can be set in a predetermined recording/playback position.

Provided in the midportion of the surface of the case 1 are a display 14 for presenting various information, a save button 15 to be manipulated when data is to be copied between the CF card, SM card or memory stick, and the optomagnetic disk, a set button 16 to be manipulated when setting one operation as selected from among a plurality of operations given on the display 14, a select button 19 when one operation is to be selected from among a plurality of operations, and a cancel button 17 to be manipulated when the selected operation is to be cancelled. Arranged on opposite sides of the save button 15 are a pair of arrow marks provided by a first LED 8 and a second LED 81 for indicating whether data is to be copied from the CF card 2, SM card 3 or memory stick to the disk 4 or from the disk 4 to the CF card 2, SM card 3 or memory stick. A power source switch 18 is provided on a side wall of the case 1.

With the electronic album device described, image data as to freeze-frame pictures or moving pictures photographed by a digital camera is written to the card medium 2 or 3 or the memory stick 9 in advance, and the image data can be copied to the disk 4 for storing. Alternatively, the image data recorded on the disk 4 can be written back to the CF card 2, SM card 3 or memory stick 9.

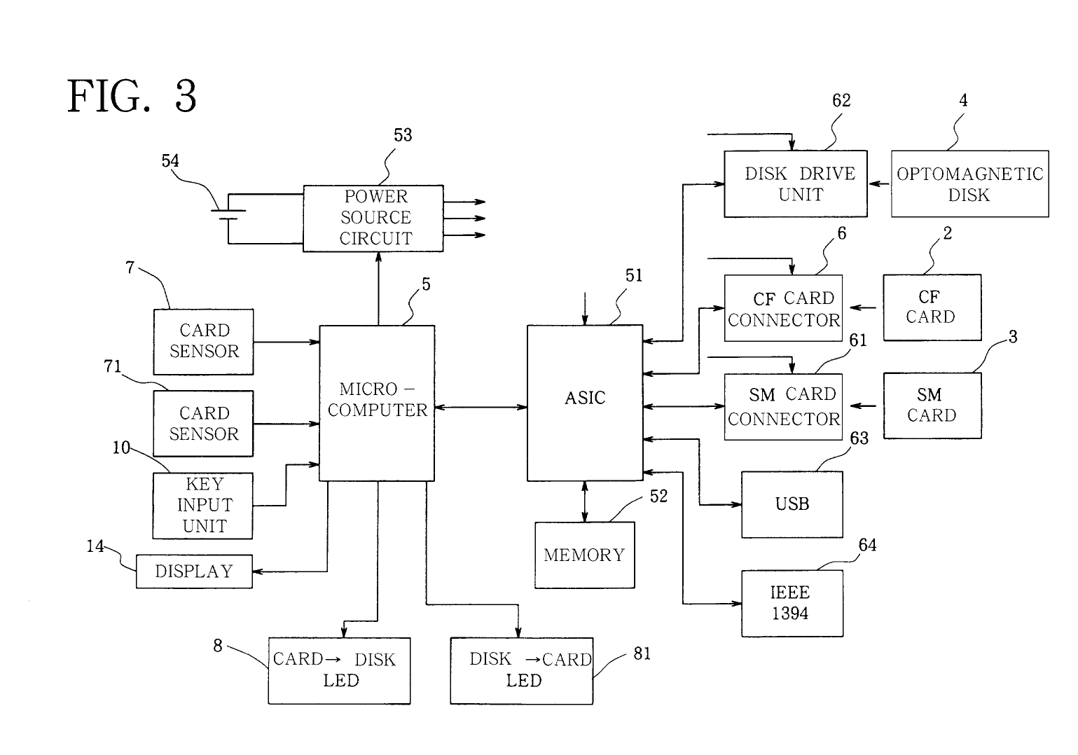

FIG. 3 shows the components providing the electronic album device. The device comprises as main circuits a microcomputer 5 for executing predetermined control operations, and ASIC 51 for processing signals as specified while performing communication with the microcomputer 5. Connected to the ASIC 51 are a disk drive unit 62 for driving the optomagnetic disk 4, a CF card connector 6 for the CF card 2 or memory stick adaptor to be inserted thereinto, and an SM card connector 61 for the SM card to be inserted thereinto. Further connected to the ASIC 51 are a USB connector 63 and IEEE 1394 connector 64 for connection to external devices such as personal computers, and a memory 52 for use in various data processing operations.

Connected to the microcomputer 5 are a card sensor 7 for detecting the CF card 2 and the memory stick adaptor, a card sensor 71 for detecting the SM card 3, a key input unit 10 comprising the foregoing buttons, the display 14, the first LED 8 and the second LED 81. A power source circuit 53 is provided for supplying the electric power of a battery 54 serving as a power source to circuit blocks under the control of the microcomputer 5.

With the disk 4 set in the case 4 of the album device described, a CF card 2 or memory stick adaptor having image data written thereto is inserted by the user into the CF card inlet 12, and the save button 15 is depressed, whereby the data is copied from the CF card 2 or memory stick to the disk 4. Alternatively an SM card 3 having image data written thereto is inserted into the SM card inlet 13 of the case 1, and the save button 15 is depressed. The data is then copied from the card 3 to the disk 4. When data is to be copied from the disk 4 to the CF card 2, SM card 3 or memory stick, the setting is changed over by mode selection.

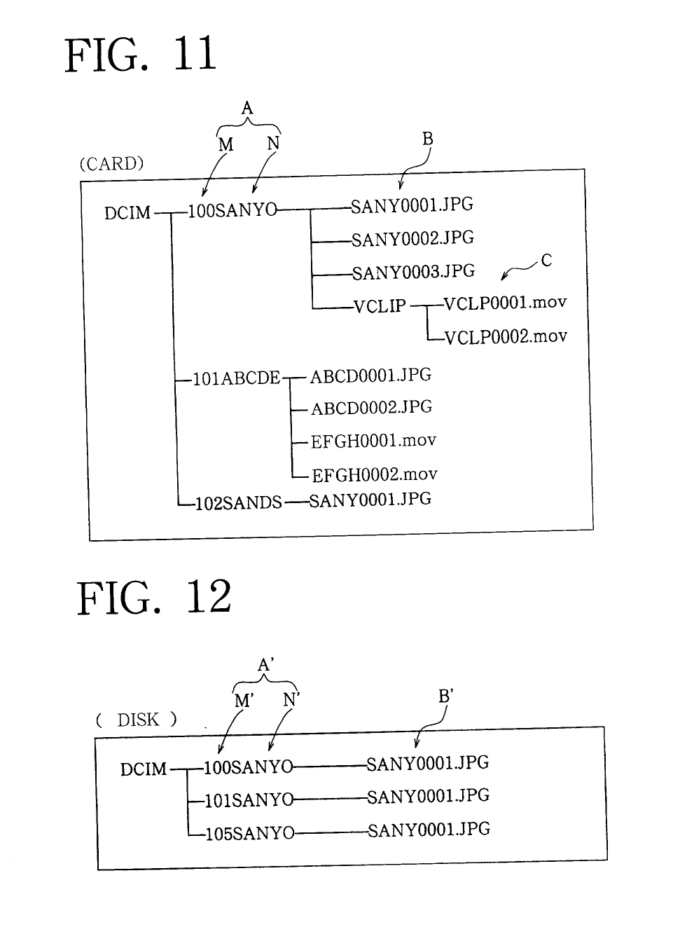

FIG. 11 shows an example of folder structure prepared on the card. The folder structure is provided only on the portion in accordance with the DCF standard. In this folder structure, the folder name of “DCIM” is defined in the uppermost stratum. In the second stratum immediately under the stratum of folder “DCIM,” folder names A are defined each of which comprises a folder number M comprising three digits and a folder identification name N comprising five Roman letters.

In the example shown in FIG. 11, provided under the folder “100SANYO” in the second stratum are three freeze-frame picture files B (“SANY0001.JPG,” “SANY0002.JPG” and “SANY0003.JPG”), and a moving picture folder name “VCLIP.” Defined under the folder name “VCLIP” are two moving picture files C (“VCLP0001.mov” and “VCLP0002.mov”). Further provided under the folder “101ABCDE” in the second stratum are two freeze-frame picture files (“ABCD0001.JPG” and “ABCD0002.JPG”) and two moving picture files (“EFGH0001.mov” and “EFGH0002.mov”). Further a freeze-frame picture file (“SANY0001.JPG”) is defined under the folder “102SANDS” in the second stratum.

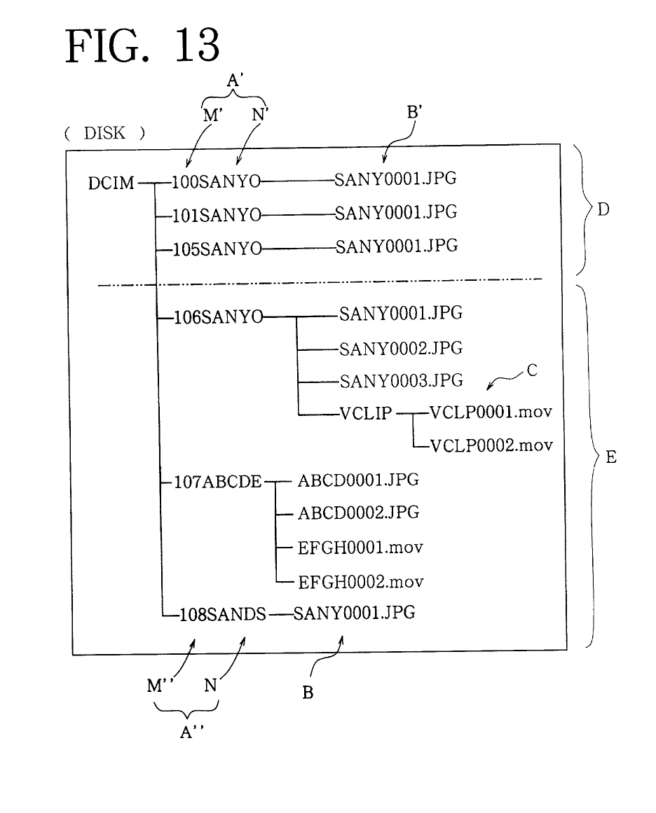

FIG. 12 shows an example of folder structure prepared on the disk. In the second stratum immediately under the folder “DCIM” in the uppermost stratum of this structure, folder names A′ are defined each of which comprises a folder number M′ comprising three digits and a folder identification name N′ comprising five Roman letters. Defined under the folder names A′ are freeze-frame picture files B′.

When the files are saved from the card of the folder structure shown in FIG. 11 to the disk of the folder structure shown in FIG. 12 by the album device of the invention, a folder structure as shown in FIG. 13 is prepared on the disk. With reference to FIG. 13, the upper region D shows the folder structure already present on the disk, and the lower region E shows the folder structure prepared anew on the disk.

As to the second stratum folder “100SANYO” shown in FIG. 11, a new folder “106SANYO” is prepared in the second stratum as seen in FIG. 13, and provided under this folder are three freeze-frame picture files B (“SANY0001.JPG,” “SANY0002.JPG” and “SANY0003.JPG”) with the same file names as on the card. Also provided under the folder “106SANYO” is a moving picture folder “VCLIP” with the same folder name as on the card. Defined under this folder are two moving picture files C (“VCLP0001.mov” and “VCLP0002.mov”) under the same file names as on the card.

As to the second stratum folder “101ABCDE” shown in FIG. 11, a new folder “107ABCDE” is prepared in the second stratum as seen in FIG. 13, and provided under this folder are two freeze-frame picture files B (“ABCD0001.JPG” and “ABCD0002.JPG”) with the same file names as on the card, and two moving picture files (“EFGH0001.mov” and “EFGH0002.mov”) under the same file names as on the card.

As to the second stratum folder “102SANDS” shown in FIG. 11, a new folder “108SANDS” is prepared in the second stratum as seen in FIG. 13, and a freeze-frame picture file (“SANY0001.JPG”) is defined under this folder with the same file name as on the card.

In copying files from a card of the folder structure comprising only the portion in accordance with the DCF standard to a disk, the disk retains the same folder structure as the card. The folder number M constituting the folder name A in the second stratum of the card is changed to a consecutive number M″ which is not same as any of the folder numbers M′ of the disk second stratum, while the same folder identification name N is retained to prepare a new folder name A″ in the second stratum of the disk. The files defined under the folders are provided under the new folder names with the same file names as on the card. Furthermore, moving picture folder “VCLIP” under the same folder name as on the card is prepared on the disk, and all the moving files defined under the moving folder “VCLIP” are defined under the folder with the same file name.

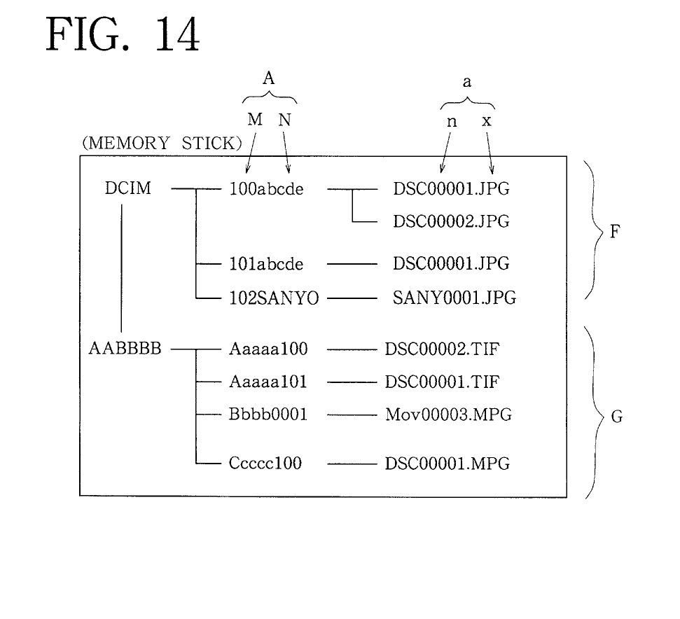

FIG. 14 shows an example of folder structure prepared on the memory stick. The folder structure is provided by a portion in conformity with the DCF standard and a portion not in conformity with this standard. The upper region F in the drawing shows the structure of the portion in conformity with the DCF standard, and the lower region G shows the structure of the other portion.

In the portion in accordance with the DCF standard, the folder of “DCIM” is provided in the uppermost stratum. In the second stratum immediately under the stratum of folder “DCIM,” folder names A are defined each of which comprises a folder number M comprising three digits and a folder identification name N comprising five Roman letters. In the example shown in FIG. 14, provided under the folder “100abcde” in the second stratum are two freeze-frame picture files (“DSC00001.JPG” and “DSC00002.JPG”). A freeze-frame picture file (“DSC00001.JPG”) is defined under the folder “101abcde.” Further a freeze-frame picture file “SANY0001.JPG”) is defined under the folder “102SANYO” in the second stratum.

In the portion not in conformity with the DCF standard, the folder of “AABBBB” is defined in the uppermost stratum. In the example shown in FIG. 14, two freeze-frame picture folders “Aaaaa100” and “Aaaaa101” are defined in the second stratum immediately under the stratum of “AABBBB,” a freeze-frame picture file (“DSC00002.TIF”) is provided under the freeze-frame picture folder “Aaaaa100, ” and a freeze-frame picture file (“DSC00001.TIF”) is provided under the freeze-frame picture folder “Aaaaa101.” Further provided in the second stratum are a moving picture folder “Bbbb0001,” with a moving picture file (“Mov00003.MPG”) provided thereunder, and a voice folder “Ccccc100,” under which is defined a voice file (“DSC0001.MPG”).

In the example of FIG. 14, the freeze-frame picture file “DSC00002.JPG” under the folder “100abcde” is prepared simultaneously when the freeze-frame picture file “DSC00002.TIF” under the folder “Aaaaa100” is prepared, and these freeze-frame files are related with each other. Furthermore, the freeze-frame picture file “DSC00001.JPG” under the folder “101abcde” is prepared simultaneously when the freeze-frame picture file “DSC00001.TIF” under the folder “Aaaaa101” is prepared, and these freeze-frame files are related with each other.

The file name a of the image file comprises a file name n and an extension x. The two freeze-frame picture files relating with each other as described above are so related by being made identical with respect to the folder number M constituting the folder name A and the file name n constituting the file name a. For example, the freeze-frame picture file “DSC00002.JPG” under the folder “100abcde” and the freeze-frame picture file “DSC00002.TIF” under the folder “Aaaaa100” both have the folder number of “100” and the file name n of “DSC00002.”

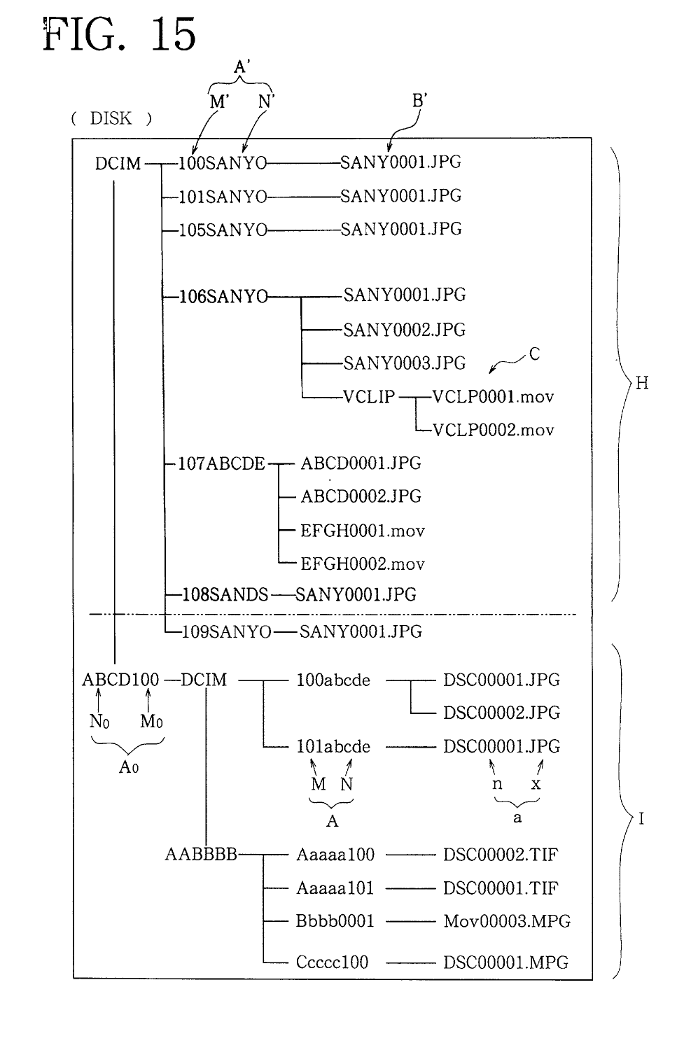

In the case where the files are saved from the memory stick of the folder structure shown in FIG. 14 to the disk of the folder structure shown in FIG. 13 by the album device of the invention, a folder structure as shown in FIG. 15 is prepared on the disk. With reference to FIG. 15, the upper region H shows the folder structure already present on the disk, and the lower region I shows the folder structure prepared anew on the disk.

With reference to FIG. 15, a view folder “ABCD100” is prepared in the uppermost position on the disk, and two folders “DCIM” and “AABBBB” are defined under this folder with the same folder names as on the memory stick.

As to the two folders “100abcde” and “101abcde” of the three folders defined under the folder “DCIM” on the memory stick, folders of the same folder names as on the memory stick are defined under the folder “DCIM” under the disk folder “ABCD100.” Defined under these folders are two freeze-frame picture files (“DSC00001.JPG” and “DSC00002.JPG”) and a freeze-frame picture file (“DSC00001.JPG”) with the same file names as on the memory stick.

As to the folder “102SANYO”, on the other hand, a new folder “109SANYO” is prepared under the folder “DCIM” defined in the uppermost stratum of the disk, and a freeze-frame picture file (“SANY0001.JPG”) is defined under this folder with the same file name as on the memory stick.

As to the four folders “Aaaaa100,” “Aaaaa101,” “Bbbb0001” and “Ccccc100” provided under the folder “AABBBB” of the memory stick, the respective folders are defined with the same folder names as on the memory stick under the folder “AABBBB” provided under the disk folder “ABCD100,” and a file (“DSC00001.JPG”) is provided under each of these folders with the same file name as on the memory stick.

When files are to be copied from the memory stick of a folder structure comprising a portion in conformity with the DCF standard and a portion not in conformity with this standard onto the disk, a new folder name A₀ is prepared at the uppermost position on the disk which name comprises a folder identification name No “ABCD” comprising four Roman letters and a folder number M₀ comprising three digits. In the case where a folder name A₀ comprising a folder identification name No “ABCD” and a folder number M₀ is already present in the uppermost position on the disk, a folder name is prepared which has a consecutive number not identical with any of the folder numbers M₀ of these folder names. For example if the folder name “ABCD101” is present, a folder name “ABCD102” is prepared.

The folder having a folder name including the folder identification name “abcde” and included among the folders defined under the folder “DCIM” of the memory stick, and all the folders defined under the folder “AABBBB” are provided under the folders “DCIM” and “AABBBB” prepared in the second stratum of the disk, with the same folder names as on the memory stick. On the other hand, the folder having a folder name not including the folder identification name “abcde” and included among the folders defined under the folder “DCIM” of the memory stick has its folder number changed to a consecutive number M″ not identical with any of the folder numbers M′ in the disk second stratum while being made to retain the same folder identification name N and is defined under the folder “DCIM” in the disk uppermost stratum.

The files defined under the folders of the memory stick are provided under the respective folders of the disk each with the same file name as on the memory stick.

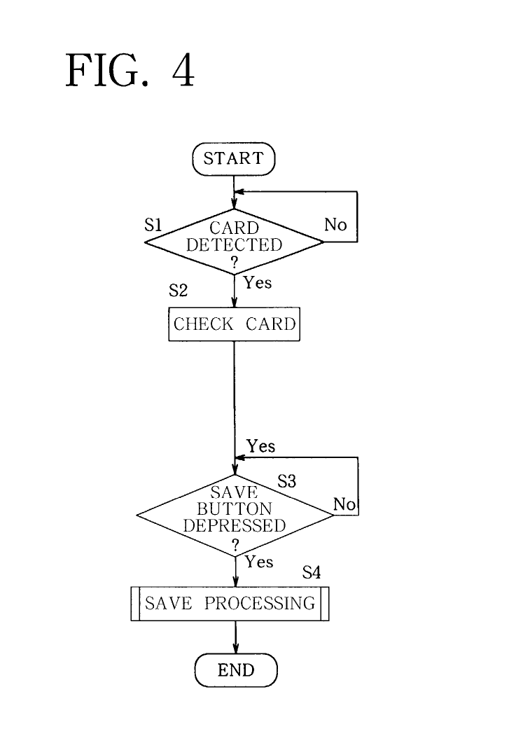

FIG. 4 shows a control procedure for copying data from the CF card 2, SM card 3 or memory stick 9 onto the optomagnetic disk. First in step S1, an inquiry is made as to whether the card or memory stick adaptor has been detected by the card sensor. If the inquiry is answered in the affirmative, step S2 follows in which the data written to the card or memory stick is checked for the type, and step S3 inquires whether the save button has been depressed.

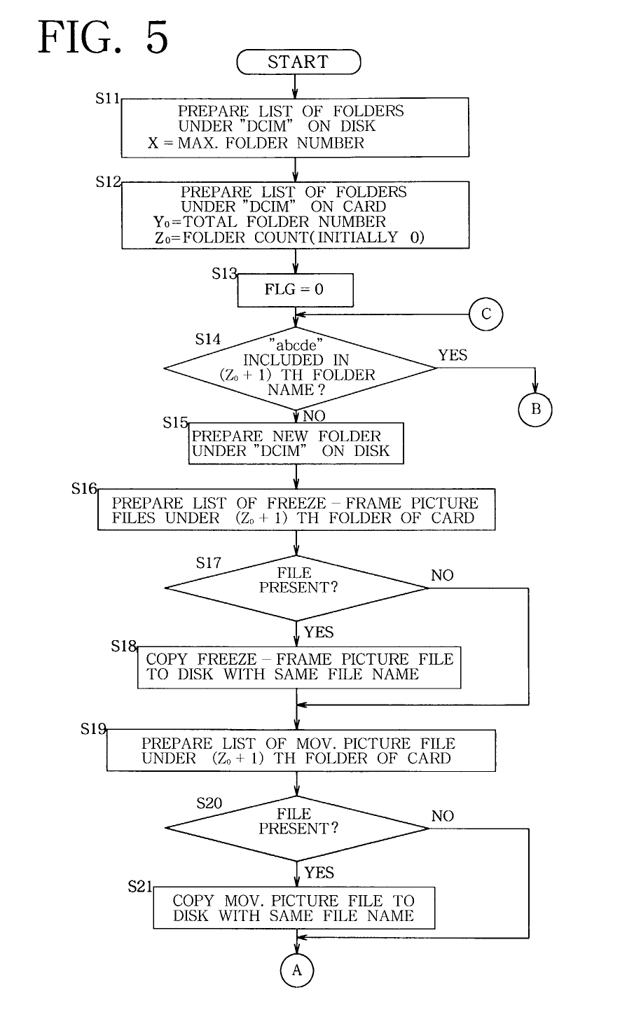

When the inquiry is answered in the affirmative, step S4 follows to execute the saving processing shown in FIGS. 5 to 10, whereupon the procedure is completed.

In data processing for saving data from the card or memory stick to the disk, a list of folders provided under the folder “DCIM” on the disk is first prepared in step S11 of FIG. 5. X in this step is the maximum value of folder number prepared in the stratum immediately under “DCIM” on the disk. Subsequently in step S12, a list is prepared from the folders provided under the folder “DCIM” on the card or memory stick. The total number of folders prepared under the folder “DCIM” on the card or memory stick is represented by Y₀, and the folder count by Z₀. The initial value for the folder count Z₀ is 0. For example when the files are copied from the card of the folder structure of FIG. 11 to the disk of the folder structure shown in FIG. 12, X is 105, and Y₀ is 3.

A flag is then initialized to “0” in FIG. 5, step S13 which flag indicates whether the folder of “AABBBB” is present in the uppermost stratum of the card or memory stick. The value “0” of the flag represents the absence of the folder “AABBBB,” while the value of “1” indicates the presence of this folder.

Subsequently in step S14, an inquiry is made as to whether a folder name of (Z₀+1)th has a folder identification name of “abcde”, and which is included among one or a plurality of folders defined under the folder “DCIM” of the card or the memory stick. In an example shown in FIG. 11, the first folder name “100SANYO” does not have the folder identification name of “abcde”, and the inquiry is answered in the negative.

When the answer for step S14 is negative, step S15 follows to prepare a new folder as to the files of the card or the memory stick under the folder “DCIM” of the disk. The folder number for the new folder is (X+Z₀+1), and the folder identification name retains the same identification name as on the card. In examples shown in FIGS. 11 and 12, X+Z₀+1 is 106, and a folder identification name of the card is “SANYO”, whereby a new folder “106SANYO” is prepared as shown in FIG. 13.

In step S16 of FIG. 5, a list is thereafter prepared of the freeze-frame picture files provided under the (Z₀+1)th folder on the card or memory stick, and step S17 inquires whether the freeze-frame picture file is present. In an example shown in FIG. 11, three freeze-frame picture files are present under the first folder “100SANYO”. If the inquiry is answered in the affirmative in step S17 of FIG. 5, step S18 follows to copy the freeze-frame picture file to the disk with the same file name as on the card or memory stick. In examples shown in FIGS. 11 to 13, the three freeze-frame picture files “SANY0001.JPG”, “SANY00002.JPG”, and “SANY0003.JPG” of the folder “100SANYO” are copied to the folder “106SANYO” with the same file name.

In step S19 of FIG. 15, a list is then prepared of the moving picture files provided under the (Z₀+1)th folder on the card or memory stick, and step S20 inquires whether the moving picture file is present. If the inquiry is answered in the affirmative, step S21 follows to copy the moving picture file to the disk with the same file name as on the card or memory stick. In the example shown in FIGS. 11 to 13, no moving picture file is provided under the first folder “100SANYO,” so that the above copying procedure is not performed.

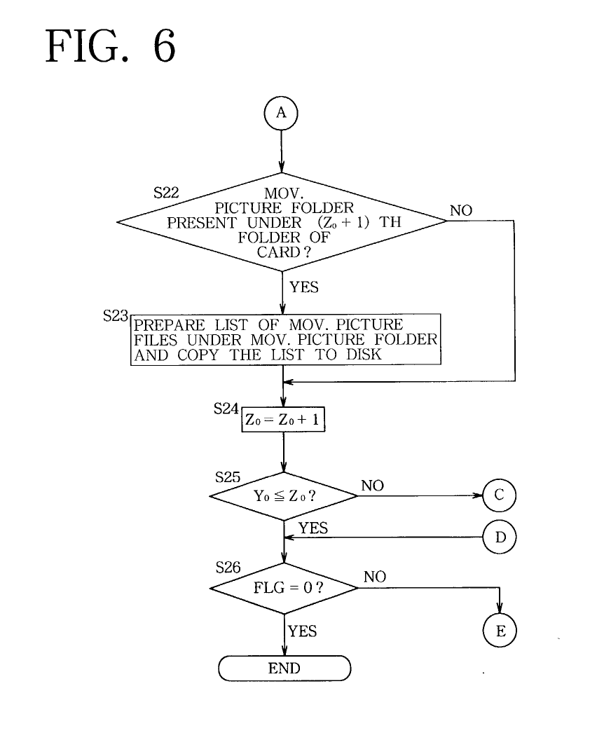

Subsequently, step S22 of FIG. 6 inquires whether the moving picture folder of “VCLIP” is present under the (Z₀+1)th folder on the card or memory stick. If the inquiry is answered in the affirmative, step S23 follows to prepare a list of moving picture files provided under the folder “VCLIP” and copy the moving picture file to the disk with the same file name as on the card or memory stick. The example of FIGS. 11 to 13 has the moving picture folder “VCLIP” under the first folder “100SANYO,” so that moving picture files “VCLP0001.mov” and “VCLP00002.mov” under the folder “VCLIP” are copied to the moving picture folder “VCLIP” prepared on the disk, with the same file names.

The folder count Z₀ is then incremented in step S24 of FIG. 6, and step S25 thereafter inquires whether the folder count value Z₀ is not smaller than the folder number Y₀ of the card or memory stick. If the answer is negative, the sequence returns to FIG. 5, step S14 to repeat the same steps as above.

With the example of FIG. 11, the folder number Y₀ of the card is 3. The same procedure as above is performed for the second folder “101ABCDE” to prepare a new folder “107ABCDE” under the disk folder “DCIM” as shown in FIG. 13. Two freeze-frame files “ABCD0001.JPG” and “ABCD0002.JPG” are copied under the folder “107ABCDE” with the same file names in FIG. 5, step S18, followed by step S21 in which two moving picture files “EFGH0001.mov” and “EFGH0002.mov” are copied with the same file names. As to the third folder “102SANDS,” a new folder “108SANDS” is prepared immediately under the disk folder “DCIM” as shown in FIG. 13, and a freeze-frame picture file “SANY0001.JPG” is copied under the folder “108SANDS” with the same file name in step S18 of FIG. 5.

When the inquiry of FIG. 6, step S25 is finally answered in the affirmative, step S26 follows to inquire whether the flag value is “0”. For example when the files are copied from the card of the folder structure shown in FIG. 11 to the disk of the folder structure of FIG. 12, the flag value, which is set at “0” in step S13 of FIG. 5, is thereafter held at “0” at all times, so that the inquiry of the step S26 is answered in the affirmative to complete the procedure of saving processing.

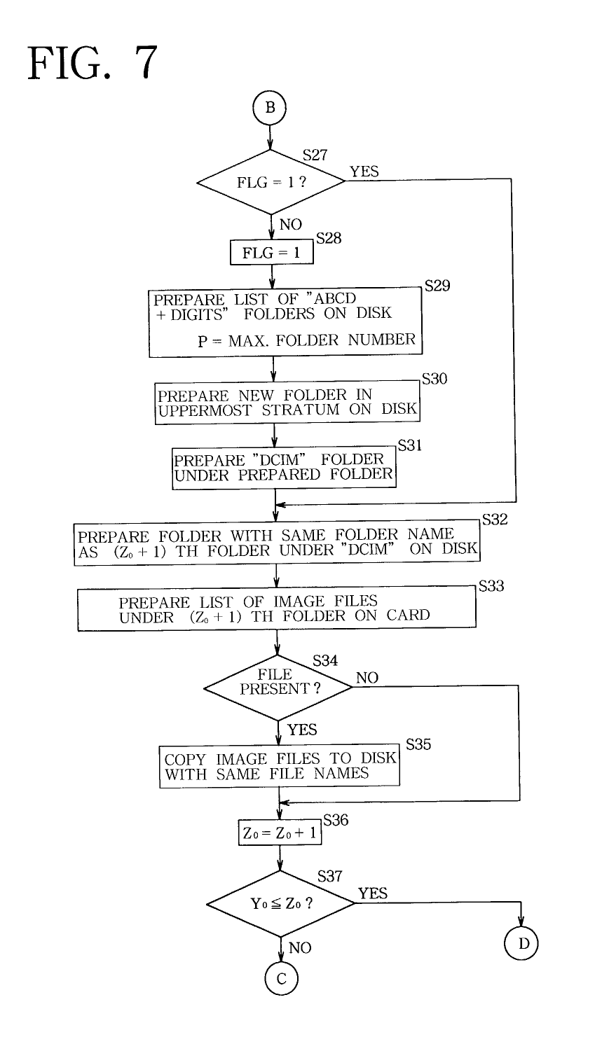

On the other hand, when files are copied from the memory stick of the folder structure of FIG. 14 to the disk of the folder structure shown in FIG. 13, X=108 and Y₀=3 in steps S11 and step S12 of FIG. 15. Since the first folder name “100abcde” includes the folder identification name “abcde,” the inquiry of step S14 is answered in the affirmative, followed by step S27 of FIG. 7, which inquires whether the flag value is “1.” When the current folder count Z₀ is 0, the inquiry is answered in the negative, while the answer is affirmative if the folder count Z₀ is not smaller than 1.

When the answer to the inquiry of step S27 is negative, step S28 follows to set the flag at “1” because in the case where a folder name having the folder identification name “abcde” is defined under the folder “DCIM” of the card or memory stick, the folder of “AABBBB” is always present in the same stratum as the folder “DCIM.”

Subsequently in step S29, a list is prepared of folders with a folder name comprising the folder identification name “ABCD” and a folder number comprising three digits, from one or a plurality of folders defined in the disk uppermost stratum. The maximum value of folder number of the folder having a folder name of such structure is herein represented by P. In the next step S30, a new folder is prepared in the disk uppermost stratum for files on the card or memory stick. At this time, a folder name comprising the folder identification name “ABCD” and a folder number “P+1” is set. In the case of the example of FIGS. 13 and 15, the disk has no folder name having the above structure, so that P=99, and a folder “ABCD100” is prepared anew.

Subsequently in step S31 of FIG. 7, a folder “DCIM” is prepared under the folder prepared above, followed by step S32 to prepare a folder with the same folder name as the (Z₀+1)th folder, which is included in one or a plurality of folders defined immediately under the stratum of the folder “DCIM” on the card or memory stick. For instance in the case of the example of FIGS. 13 to 15, the folder “DCIM” is prepared immediately under the folder “ABCD100”, and the first folder “100abcde” on the memory stick is prepared under this folder with the same folder name.

Thereafter prepared in step S33 of FIG. 7 is a list of files provided under the (Z₀+1)th folder on the card or memory stick. Step S34 inquires whether files are present under the (Z₀+1) folder. For instance with the example of FIG. 14, two image files are present under the first folder “100abcde.” When the answer to the inquiry of FIG. 7, step S34 is affirmative, step S35 follows to copy the files to the disk with the same file names as on the card or memory stick. For instance in the case of the example of FIGS. 13 to 15, two image files “DSC0001.JPG” and “DSC0002.JPG” under the folder “100abcde” are copied to the disk folder “100abcde” with the same file names.

The folder count Z₀ is then incremented in step S36 of FIG. 7, and step S37 thereafter inquires whether the folder count value Z₀ is not smaller than the folder number Y₀ of the card or memory stick. If the answer is negative, the sequence returns to FIG. 5, step S14 to repeat the same steps as above.

With the example of FIG. 14, the folder number Y₀ defined under the folder “DCIM” on the memory stick is 3, so that a procedure for the second folder “101abcde” subsequent to the first folder “100abcde” is performed. Since the second folder “101abcde” includes the folder identification name of “abcde” in its folder name, the same procedure as for the first folder is executed. However, the inquiry of FIG. 7, step S27 is answered in the affirmative, a folder “101abcde” is prepared under the folder “DCIM” already prepared, and an image file “DSC0001.JPG” is copied under the folder “101abcde.” As regards the third folder “102SANYO,” the folder identification name “abcde” is not included in the folder name, so that the inquiry of FIG. 5, step S14 is answered in the negative, and steps S15 to FIG. 6, step S25 are performed, whereby a new folder “109SANYO” is prepared under the folder “DCIM” in the uppermost stratum on the disk, and a freeze-frame picture file “SANY0001.JPG” is copied to the level under the folder “109SANYO.”

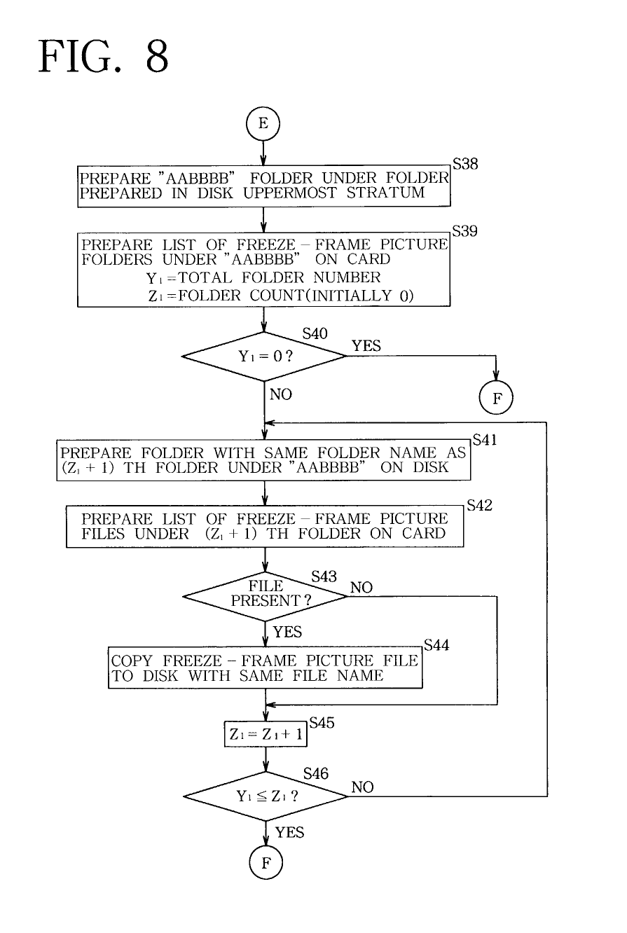

When the inquiry of FIG. 6, step S25 or FIG. 7, step S37 is finally answered in the affirmative, step S26 of FIG. 6 follows to inquire whether the flag value is “0”. For example when the files are copied from the memory stick of the folder structure shown in FIG. 14 to the disk of the folder structure of FIG. 13, the flag value, which is set at “1” in step S28 of FIG. 7, is therafter held at “1” at all times, so that the inquiry of the step S26 is answered in the negative, followed by FIG. 8, step S38.

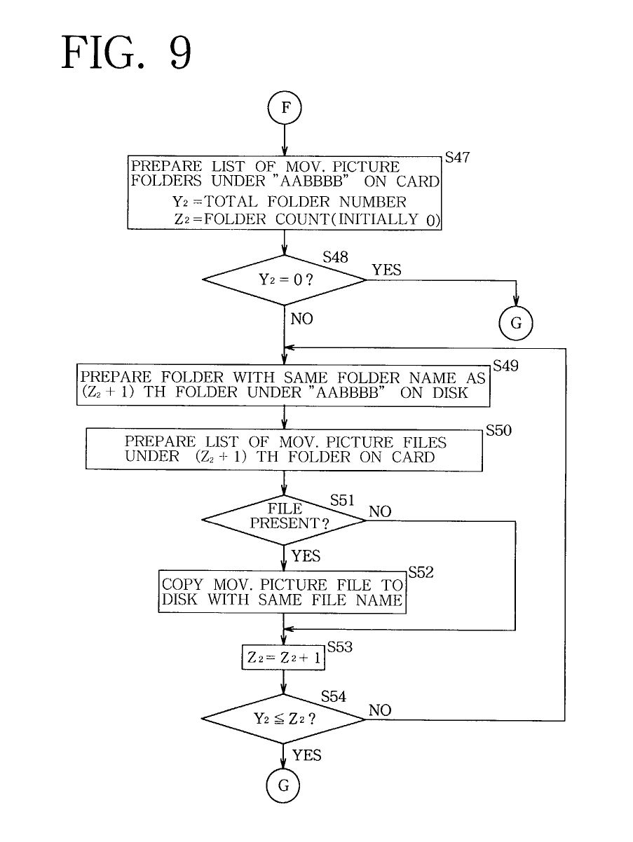

In step S38, a folder “AABBBB” is prepared under the folder formed in the uppermost stratum on the disk, i.e., under the folder having a folder name comprising the folder identification name “ABCD” and a three-digit folder number. Step S39 then follows to prepare a list of freeze-frame picture folders provided under the folder “AABBBB” on the card or memory stick. Y₁ is now used to represent the total number of freeze-frame picture folders prepared under the folder “AABBBB” on the card or memory stick, and Z₁ is used to represent the folder count value. The folder count value Z₁ is initially set at 0. For instance, the example of FIG. 14 has two freeze-frame picture folders “Aaaaa100” and “Aaaaa101” defined under the folder “AABBBB,” and Y₁=2. Step S40 of FIG. 8 then inquires whether the freeze-frame picture folder number Y₁ on the card or memory stick is 0. If the answer is negative, step S41 follows, while if the answer is affirmative, step S47 of FIG. 9 follows. For instance in the case of the example of FIG. 14, Y₁=2 as stated above, so that the answer is negative.

Prepared in step S41 under the folder “AABBBB” on the disk is a freeze-frame picture folder with the same folder name as the (Z₁+1)th folder which is included in one or a plurality of freeze-frame picture folders defined immediately under the stratum of “AABBBB” on the card or memory stick. For instance in the case of the example of FIGS. 13 to 15, a first freeze-frame picture folder “Aaaaa100” is prepared under the disk folder “AABBBB.” In step S42 of FIG. 8, a list is thereafter prepared of freeze-frame picture files provided under the (Z₁+1)th freeze-frame picture folder on the card or memory stick, and step S43 inquires whether a freeze-frame picture file is present under the (Z₁+1)th freeze-frame picture folder. For instance, the example of FIG. 14 has one freeze-frame picture file under the first freeze-frame picture folder “Aaaaa100.” When the inquiry of FIG. 8, step S43 is answered in the affirmative, step S44 follows to copy the freeze-frame picture file to the disk with the same file name as on the card or memory stick. With the examples of FIGS. 13 to 15, the freeze-frame picture file “DSC00002.TIF” under the folder “Aaaaa100” on the memory stick is copied to a level under the disk folder “Aaaaa100” with the same file name. The folder count Z₁ is then incremented in step S45 of FIG. 8, and step S46 thereafter inquires whether the folder count value Z₁ is not smaller than the folder number Y₁ of the card or memory stick. If the answer is negative, the sequence returns to step S41 to repeat the same steps as above. In the case of the example of FIG. 14, the freeze-frame picture folder number Y₁ is 2, the same procedure as above is performed for the second folder “Aaaaa101,” a new folder “Aaaaa101” is prepared under the disk folder “AABBBB” as shown in FIG. 15, and a freeze-frame picture file “DSC00001.JPG” is copied under this folder.

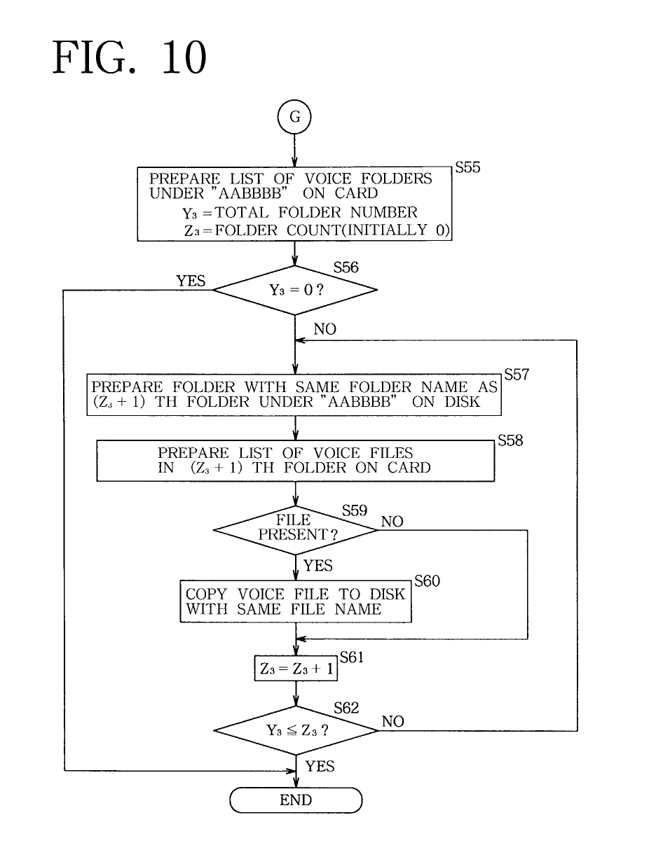

When the inquiry of FIG. 8, step S46 is finally answered in the affirmative, step S47 of FIG. 9 follows. This step S47 prepares a list of moving picture folders provided under the folder “AABBBB” on the card or memory stick. Y₂ is now used to represent the total number of moving picture folders prepared under the folder “AABBBB” on the card or memory stick, and Z₂ is used to represent the folder count value. The folder count value Z₂ is initially set at 0. For instance, the example of FIG. 14 has a moving picture folder “Bbbb0001” under the folder “AABBBB,” and Y₂=1. Step S48 of FIG. 9 then inquires whether the moving picture folder number Y₂ on the card or memory stick is 0. If the answer is negative, step S49 follows, while if the answer is affirmative, step S55 of FIG. 10 follows. For instance in the case of the example of FIG. 14, Y₂=1 as stated above, so that the answer is negative. Prepared in step S49 under the folder “AABBBB” on the disk is a moving picture folder with the same folder name as the (Z₂+1)th folder which is included in one or a plurality of moving picture folders defined immediately under “AABBBB” on the card or memory stick. For instance in the case of the example of FIGS. 13 to 15, a first moving picture folder “Bbbb0001” is prepared under the disk folder “AABBBB.” In step S50 of FIG. 9, a list is thereafter prepared of moving picture files provided under the (Z₂+1)th moving picture folder on the card or memory stick, and step S51 inquires whether a moving picture file is present under the (Z₂+1)th moving picture folder. For instance, the example of FIG. 14 has one moving picture file under the first moving picture folder “Bbbb0001.” When the inquiry of FIG. 9, step S51 is answered in the affirmative, step S52 follows to copy the moving picture file to the disk with the same file name as on the card or memory stick. With the example of FIGS. 13 to 15, the moving picture file “Mov00003.MPG” under the folder “Bbbb0001” on the memory stick is copied to a level under the disk moving picture folder “Bbbb0001” with the same file name. The folder count Z₂ is then incremented in step S53 of FIG. 9, and step S54 thereafter inquires whether the folder count value Z₂ is not smaller than the folder number Y₂ of the card or memory stick. If the answer is negative, the sequence returns to step S49 to repeat the same steps as above.

When the inquiry of step S54 is finally answered in the affirmative, step S55 of FIG. 10 follows. This step S55 prepares a list of voice folders provided under the folder “AABBBB” on the card or memory stick. Y₃ is now used to represent the total number of voice folders prepared under the folder “AABBBB” on the card or memory stick, and Z₃ is used to represent the folder count value. The folder count value Z₃ is initially set at 0. For instance, the example of FIG. 14 has a voice folder “Ccccc100” under the folder “AABBBB,” and Y₃=1. Step S56 then inquires whether the voice folder number Y₃ on the card or memory stick is 0. If the answer is negative, step S57 follows, while if the answer is affirmative, the saving processing procedure is completed. For instance in the case of the example of FIG. 14, Y₃=1 as stated above, so that the answer is negative.

Prepared in step S57 under the folder “AABBBB” on the disk is a voice folder with the same folder name as the (Z₃+1)th folder which is included in one or a plurality of voice folders defined immediately under “AABBBB” on the card or memory stick. For instance in the case of the example of FIGS. 13 to 15, a first voice folder “Ccccc100” is prepared under the disk folder “AABBBB.” In step S58 of FIG. 10, a list is thereafter prepared of voice files provided under the (Z₃+1)th voice folder on the card or memory stick, and step S59 inquires whether a voice file is present under the (Z₃+1)th voice folder. For instance, the example of FIG. 14 has one voice file under the first voice folder “Ccccc100.” When the inquiry of FIG. 10, step S59 is answered in the affirmative, step S60 follows to copy the voice file to the disk with the same file name as on the card or memory stick. With the example of FIGS. 13 to 15, a voice file “DSC00001.MPG” under the voice folder “Ccccc100” on the memory stick is copied to a level under the disk voice folder “Ccccc100” with the same file name. The folder count Z₃ is then incremented in step S61 of FIG. 10, and step S62 thereafter inquires whether the folder count value Z₃ is not smaller than the folder number Y₃ of the card or memory stick. If the answer is negative, the sequence returns to step S57 to repeat the same steps as above.

When the inquiry of step S62 is eventually answered in the affirmative, the saving processing procedure is completed.

In copying files to a disk from a card having a folder structure comprising only a portion in conformity with the DCF standard by the album device of the invention, the folder number M of each folder on the card is changed to a consecutive number which is different from any of folder numbers M′ on the disk, with the result the desired file provided under an optional folder can be read by virtue of the new folder structure on the disk.

Since the same folder structure is maintained in copying the file from the card to the disk, the file will thereafter be written from the disk to the card, with the same folder structure maintained. The file can then be reproduced free of trouble using the original digital camera. A voice folder or successive photographing folder may be provided on the card, with voice files or successive photographic files obtained by successive photographing operations and provided under such a folder. Even in such a case, these files can be reproduced with the original digital camera like moving picture files.

Since the same folder identification name N of the folder name is maintained in copying files from the card to the disk, the folder identification name N of the folder name readily indicates the digital camera of particular manufacturer by which the file can be reproduced when the file is written back from the disk to the card.

The same file name B or C is maintained under each folder. This assures facilitated file management.

In copying files to a disk from a memory stick having a folder structure comprising a portion in conformity with the DCF standard and a portion not in conformity with the DCF standard as shown in FIGS. 13 to 15, a plurality of folders defined under the folder “DCIM” include folders having the folder identification name of “abcde” and all folders defined under the folder “AABBBB.” While being copied, each of these folder retains the same folder name, while each file defined under each folder retain the same file name. When the files are thereafter written back from the disk to the memory stick, each with the same folder name and file name retained, the files can be reproduced by the original digital camera without any trouble. Furthermore, freeze-frame picture files which are related with each other will not become broken in this relation, and when these files are written back to the memory stick with the folder name and file name maintained, the files can be reproduced with the original digital camera.

The folder name A₀ having a consecutive number which is different from any of folder numbers M₀ in the uppermost stratum on the disk is defined in the uppermost stratum of the disk, and the folder on the memory stick is provided under the folder name. Accordingly, the desired file defined under an optional folder can be read without any trouble by virtue of the new folder structure on the disk.

The folders defined under the folder “DCIM on the memory stick include a folder which does not have the folder identification name of “abcde”, e.g. the folder “102SANYO” in the example of FIG. 14, has its folder number M changed to a number M″ which is different from any of folder numbers M′ on the disk and is defined under the folder “DCIM” in the disk uppermost stratum. Accordingly if the files defined under such a folder are written back from the disk to the card, the files can be reproduced with a digital camera for preparing a folder structure conforming to the DCF standard.

Furthermore for card media having a folder structure including a portion not in conformity with the DCF standard, the album device of the invention is adapted for the same saving processing as for the memory stick.

What is claimed is:

1. An electronic album device loadable with a data recording medium for reading all files from the data recording medium and recording the files on a data saving medium, the album device being operable to copy the file from the data recording medium to the data saving medium by preparing a new folder structure on the data saving medium without substantially changing a folder structure prepared on the data recording medium.

2. An electronic album device loadable with a data recording medium for reading all files from the data recording medium and recording the files on a data saving medium, the album device comprising:
first recognizer for recognizing a folder structure prepared on the data recording medium,
second recognizer for recognizing a folder structure prepared on the data saving medium,
folder name preparator for preparing a new folder name A″ by changing a folder number M constituting the folder name A of each folder in the folder structure on the data recording medium to a number M″ different from any of folder numbers M′ on the data saving medium,
folder structure preparator for preparing on the data saving medium a new folder structure having the same folder construction as the data recording medium with use of the new folder name A″, and
copying processor for copying the file from the data recording medium to the data saving medium with the new folder structure prepared on the data saving medium.

3. An electronic album device according to claim 2 wherein the folder name A of each folder comprises the folder number M and a folder identification name N, and the folder name preparator prepares the new folder name A″ while maintaining the same folder identification name N.

4. An electronic album device according to claim 3 wherein the folder structure preparator prepares the new folder structure by maintaining the same file name B defined under each folder.

5. An electronic album device according to claim 2 wherein for a plurality of moving picture files defined under a moving picture folder, a moving picture folder is prepared on the data saving medium, the album device comprising moving picture file definer for defining all the moving picture files under the moving picture folder prepared while maintaining the same file name for each of the moving picture files.

6. An electronic album device according to claim 2 wherein in the case where the folder structure on the data recording medium is in conformity with a predetermined format, the folder name preparator performs the folder name preparing operation, and the folder structure preparator performs the folder structure preparing operation while maintaining the predetermined format.

7. An electronic album device according to claim 6 which comprises:
nonconforming folder name preparator for preparing a new folder name A₀ having a folder number M₀ different from any folder number constituting the folder name in the uppermost stratum on the data saving medium, and
nonconforming folder structure preparator for preparing on the data saving medium a new folder structure having under the new folder name A₀ the same folder name and the same file name as each folder name A prepared on the data recording medium and as the file name a defined under the folder name A, when the folder structure on the data recording medium includes a portion in conformity with the predetermined format and a portion not in conformity with the format.

8. An electronic album device according to claim 7 which comprises judge for judging whether each of the folders defined on the data recording medium is related with any other folder, and wherein the folder name preparator performs the folder name preparing operation for the folder which is not related with any other folder and which is the folder defined in the portion conforming to the predetermined format or is included among folders defined in the conforming portion, and the folder structure preparator defines the new folder name prepared for the nonrelated folder on the data saving medium while maintaining the predetermined format.

9. In an electronic album device loadable with a data recording medium for reading all files from the data recording medium and recording the files on a data saving medium, a file copying method of copying the file from the data recording medium to the data saving medium by preparing a new folder structure on the data saving medium without substantially changing the folder structure prepared on the data recording medium.

10. A file copying method for use in an electronic album device loadable with a data recording medium for reading all files from the data recording medium and recording the files on a data saving medium, the file copying method having:
the first step of recognizing the folder structure prepared on the data recording medium and recognizing the folder structure prepared on the data saving medium, and
the second step of repeating the folder preparation step of preparing on the data saving medium a folder having a new folder name for each folder prepared on the data recording medium and the copying step of copying the file from the folder on the data recording medium to the folder prepared on the data saving medium, the folder preparation step of the second step having:
the step of preparing a new folder name A″ by changing a folder number M constituting the folder name A of the folder on the data recording medium to a number M″ different from any of folder numbers M′ on the data saving medium, and
the step of preparing a folder having the new folder name A″ in the same stratum as the folder on the data recording media.
